(19) United States
(12) Patent Application Publication
(10) Pub. No.: US 2018/0213271 A1
(43) Pub. Date: Jul. 26, 2018

(54) LOCATION-BASED SYSTEM AND METHOD FOR CONTROLLING CONTENT DISTRIBUTION TO A SET TOP BOX

(71) Applicant: The DIRECTV Group, Inc., El Segundo, CA (US)

(72) Inventors: Premal Shah, Cerritos, CA (US); Carlos A. Moz, Chino Hills, CA (US); Viral R. Shah, Cerritos, CA (US)

(21) Appl. No.: 15/415,723

(22) Filed: Jan. 25, 2017

(51) Int. Cl. H04N 21/258; H04N 21/61; H04N 21/254; H04N 21/435; H04N 21/4627; H04N 21/414; H04N 21/45; H04N 21/442

(52) U.S. Cl. CPC H04N 21/25841; H04N 21/6143; H04N 21/6193; H04N 21/2541; H04N 21/44213; H04N 21/4627; H04N 21/414; H04N 21/4524; H04N 21/435

(57) ABSTRACT

In one example, the present disclosure describes a device, computer-readable medium, and method for the controlling the distribution of video programs and other data to a set top box based on the geographic location of the set top box. For instance, in one example, a device includes a processor and a computer-readable medium storing instructions which, when executed by the processor, cause the processor to perform operations. The operations include determining a time to send a current geographic location of the device to a remote server, sending a first signal to the remote server, wherein the current geographic location is encoded in the first signal, extracting an instruction from a second signal sent by the remote server in response to the first signal, and taking an action in response to the instruction, wherein the action alters an ability of the device to process a satellite signal.

The present disclosure relates generally to the presentation of video programs, and more particularly to devices, non-transitory computer-readable media, and methods for controlling the distribution of video programs and other data to a set top box based on the geographic location of the set top box.

### BACKGROUND

Fraudulent, unauthorized sharing of equipment used to provide satellite television services to customer premises results in potentially significant financial losses to providers of the services. For instance, a customer may lend a set top box (STB) and/or a satellite receiver to an unauthorized user, who may then be able to connect the equipment in a way that allows the unauthorized user to receive the satellite television services without paying for them.

### SUMMARY

In one example, the present disclosure describes a device, computer-readable medium, and method for the controlling the distribution of video programs and other data to a set top box based on the geographic location of the set top box. For instance, in one example, a device includes a processor and a computer-readable medium storing instructions which, when executed by the processor, cause the processor to perform operations. The operations include determining a time to send a current geographic location of the device to a remote server, sending a first signal to the remote server, wherein the current geographic location is encoded in the first signal, extracting an instruction from a second signal sent by the remote server in response to the first signal, and taking an action in response to the instruction, wherein the action alters an ability of the device to process a satellite signal.

In another example, method includes determining, by a device, a time to send a current geographic location of the device to a remote server, sending, by the device, a first signal to the remote server, wherein the current geographic location is encoded in the first signal, extracting, by the device, an instruction from a second signal sent by the remote server in response to the first signal, and taking an action, by the device, in response to the instruction, wherein the action alters an ability of the device to process a satellite signal.

In another example, a method includes extracting, by a server, a geographic location from a first signal sent by a remote device, identifying, by the server, the remote device using identifying data extracted from the first signal, determining, by the server, that the geographic location is outside of a geographic radius within which the remote device is permitted to operate, and, in response to the determining, sending, by the server, a second signal to the remote device, wherein the second signal encodes an instruction instructing the remote device to take an action that alters an ability of the remote device to process a satellite signal.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for monitoring the location of a set top box in accordance with the present disclosure;

FIG. 3 illustrates a flowchart of another example method for monitoring the location of a set top box in accordance with the present disclosure; and

FIG. 4 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides for controlling the distribution of video programs and other data to a set top box (STB) based on the geographic location of the STB. As discussed above, fraudulent, unauthorized sharing of equipment used to provide satellite television services to customer premises results in potentially significant financial losses to providers of the services. For instance, a customer may lend a STB and/or a satellite receiver to an unauthorized user, who may then be able to connect the equipment in a way that allows the unauthorized user to receive the satellite television services without paying for them.

Examples of the present disclosure employ a “smart” STB including an embedded position sensor that allows the STB to determine its geographic location. The STB may send signals to a remote server that include an indication of the STB's current geographic location. These signals may be sent periodically (e.g., every x days), at random times, whenever a change in location that is larger than some predefined amount (e.g., more than y feet) is detected, or on any other basis. If, upon receiving a signal from the STB, the remote server determines that the STB's geographic location has moved outside of some predefined permitted radius, the remote server may send a signal to the STB that effectively disables the STB and prevents it from receiving or playing back content.

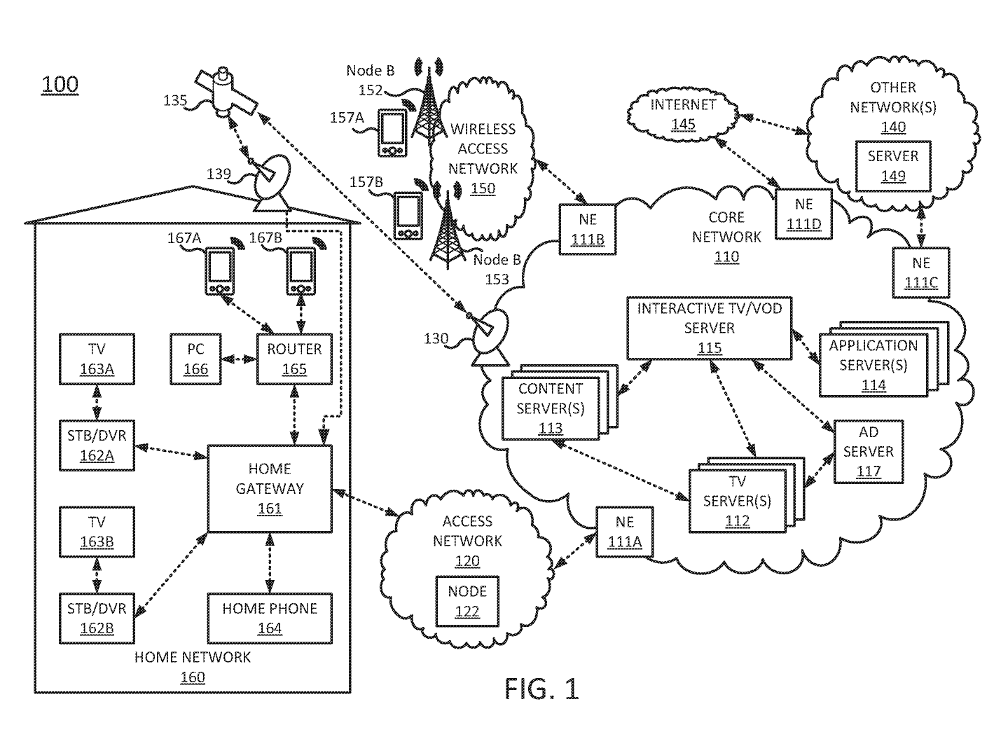

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140 and/or the Internet 145.

In one embodiment, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology. While the present disclosure is not limited to any particular type of wireless access network, in the illustrative embodiment, wireless access network 150 is shown as a UMTS terrestrial radio access network (UTRAN) subsystem. Thus, elements 152 and 153 may each comprise a Node B or evolved Node B (eNodeB).

In one embodiment, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one embodiment, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an interactive TV/video on demand (VOD) server 115 (e.g., an application server). For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113, advertising server 117, and interactive TV/VOD server 115 to select which video programs, or other content and advertisements to provide to the home network 160 and to others.

In one example, content servers 113 may store scheduled television broadcast content for a number of television channels, video-on-demand programming, local programming content, and so forth. For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160 and at other downstream viewing locations. For example, advertisers may upload various advertising content to the core network 110 to be distributed to various viewers.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another embodiment node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

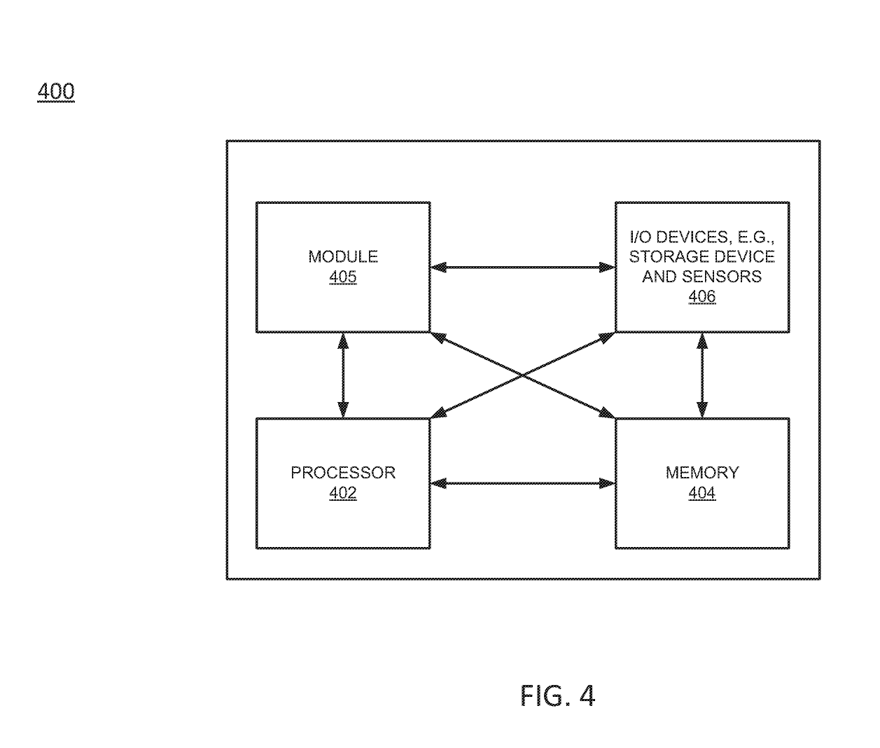

In one example, one or both of the STB/DVR 162A and STB/DVR 162B may comprise a computing system or server, such as computing system 400 depicted in FIG. 4, which includes an embedded position sensor for detecting the current geographic location of the STB/DVR 162A or STB/DVR 162B, as described herein. One or both of the STB/DVR 162A and STB/DVR 162B is further configured to decode data streams and to forward decoded data to a paired TV 163A or 163B for display. It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

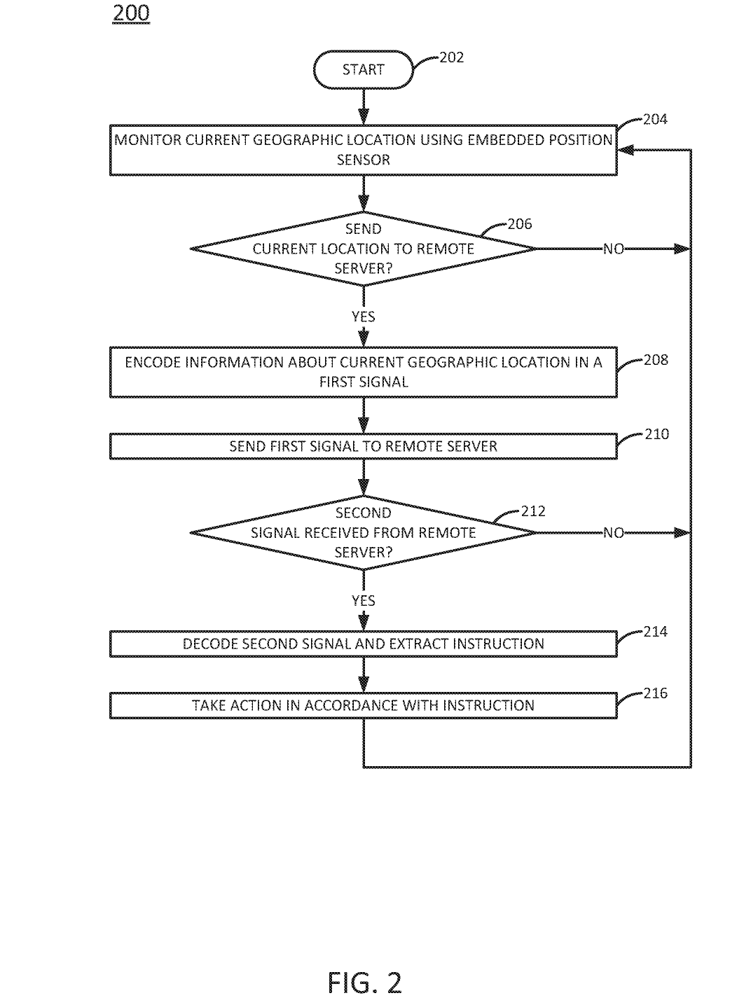

To further aid in understanding the present disclosure, FIG. 2 illustrates a flowchart of an example method 200 for monitoring the geographic location of a set top box (STB) in accordance with the present disclosure. In one example, the method 200 may be performed by a set top box that is configured to decode data streams received via a satellite receiver, such as the STB/DVRs 162A and 162B illustrated in FIG. 1.

The method 200 begins in step 202. In step 204, the STB monitors its current geographic location. In one example, the STB monitors its geographic location using an embedded position sensor that detects information about at least the current location of the STB (e.g., coordinates such as latitude and longitude). For instance, the position senior may be a global positioning system (GPS) sensor. In another example, the position sensor further includes an accelerometer or other sensor that detects movement of the STB.

In step 206, the STB determines whether it should send information about its current geographic location to a remote server, such as one or more of the TV servers 112 or application servers 114. In one example, the STB sends information about its current geographic location periodically (e.g., every x days). In another example, the STB sends information about its current geographic location at random times. In yet another example, the STB sends information about its current geographic location whenever the monitoring of step 204 indicates that the current location has changed by more than some predefined amount during a predefined window of time (e.g., more than y feet in z minutes).

If the STB concludes in step 206 that it should not send information about its current geographic location to the remote server, then the method returns to step 204, and the STB continues to monitor its current geographic location.

If, however, the STB concludes in step 206 that it should send information about its current geographic location to the remote server, then the method proceeds to step 208, and the STB encodes information about its current geographic location, as detected by the in accordance with the monitoring of step 204, in a first signal. In one example, the first signal comprises one or more data packets that may be transmitted over an Internet Protocol (IP) network.

In step 210, the STB sends the first signal to the remote server. In one example, the first signal may be transmitted via an access network (e.g., access network 120 of FIG. 1) to a core network including the remote server (e.g., core network 110 of FIG. 1). In another example, the first signal may be transmitted via a satellite (e.g., satellite 135 of FIG. 1) to the core network, if the STB is in communication with a satellite receiver (e.g., satellite receiver 139) that includes antennas for uplink communications.

In step 212, the STB determines whether a response in the form of a second signal has been received from the remote server.

If the STB concludes in step 212 that a response from the remote server has not been received, then the method returns to step 204, and the STB continues to monitor its current geographic location.

If, however, the STB concludes in step 212 that a response from the remote server has been received, then the method proceeds to step 214, where the STB decodes the second signal and extracts an instruction from the decoded second signal. In one example, decoding the second signal involves extracting a plurality of data packets from the second signal and ordering the plurality of data packets in order to reconstruct the instruction.

In step 216, the STB takes an action in accordance with the instruction. In one example, the action alters an ability of the STB to process a satellite signal. For instance, if the remote server has determined that the STB's current geographic location is outside of a predefined permissible geographic radius, the instruction may instruct the STB to at least temporarily cease receiving satellite signals and/or playing back content decoded from satellite signals.

Assuming that the instruction does not include an instruction to disable the STB's communication interfaces, the method 200 may at this point return to step 204, and the STB may continue to monitor its current geographic location. This will allow the remote server to track the STB's geographic location and potentially allow a service provider to recover the STB.

Alternatively, if the instruction does include an instruction to disable the STB's communication interfaces, the method 200 may simply end without continued monitoring of the STB's geographic location.

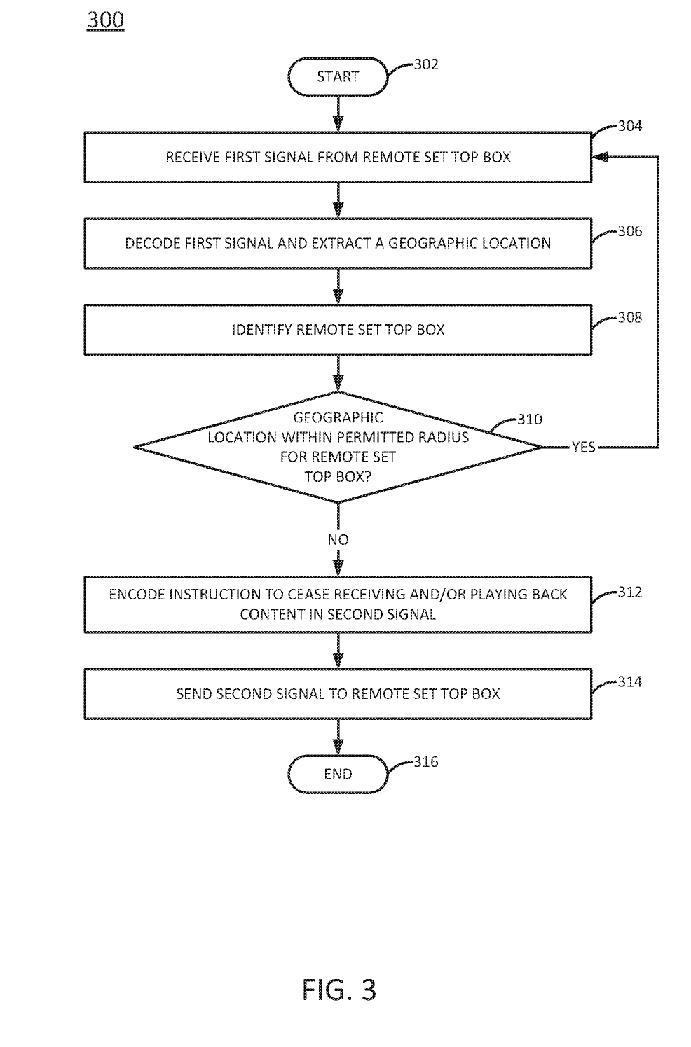

FIG. 3 illustrates a flowchart of another example method 300 for monitoring the location of a set top box (STB) in accordance with the present disclosure. In one example, the method 200 may be performed by a server, such as one or more of the TV servers 112 or application servers 114 illustrated in FIG. 1

The method 300 begins in step 302. In step 304, the server receives a first signal from a remote STB. In one example, the remote STB is a set top box that is configured to decode data streams received via a satellite receiver, such as the STB/DVRs 162A and 162B illustrated in FIG. 1. The remote STB may include an embedded position sensor that allows it to monitor its geographic location. In one example, the first signal may comprise one or more data packets that may be transmitted over an Internet Protocol (IP) network. For instance, the first signal may be transmitted via an access network (e.g., access network 120 of FIG. 1) to a core network including the server (e.g., core network 110 of FIG. 1). In another example, the first signal may be transmitted via a satellite (e.g., satellite 135 of FIG. 1) to the core network, if the remote STB is in communication with a satellite receiver (e.g., satellite receiver 139) that includes antennas for uplink communications.

In step 306, the server decodes the first signal and extracts a geographic location from the decoded second signal. In one example, decoding the first signal involves extracting a plurality of data packets from the first signal and ordering the plurality of data packets in order to reconstruct the data.

In step 308, the server identifies the remote STB using identifying data contained in the plurality of data packets. In one example, the identifying data is contained in a header or footer of at least one of the data packets. For instance, the identifying data may include a network address such as an Internet Protocol (IP) address or a media access control (MAC) address, or another unique identifier such as a serial number.

In step 310, the server determines, based on the identification and on the geographic location extracted from the signal, whether the remote STB is permitted to operate in its current geographic location. In one example, the server may have access to a table or other data structure that defines, for one or more remote STBs, a geographic radius within which each of the remote STBs is permitted to operate.

If the server concludes in step 310 that the remote STB is permitted to operate in its current geographic location (e.g., the current geographic location is within the permitted geographic radius), then the method 300 may end in step 316. In this case, no further action may be taken; the remote STB may continue to receive and play back content without interruption. This content may be provided to the remote STB by the server, or by another server (e.g., another server in the core network).

Alternatively, if the server concludes in step 310 that the remote STB is not permitted to operate in its current geographic location (e.g., the current geographic location is outside of the permitted geographic radius), then the method 300 proceeds to step 312, and the server encodes an instruction in a second signal. In one example, the second signal comprises one or more data packets that may be transmitted over an Internet Protocol (IP) network. In one example, the instruction alters an ability of the remote STB to process a satellite signal. For instance, the instruction may comprise an instruction to the remote STB to at least temporarily cease receiving and/or playing back content encoded in a satellite signal.

In step 314, the server sends the second signal to the remote STB. In one example, the second signal may be transmitted via an access network (e.g., access network 120 of FIG. 1) to a home gateway that is in communication with the remote STB (e.g., home gateway 161 of FIG. 1). In another example, the second signal may be transmitted via a satellite (e.g., satellite 135 of FIG. 1) to the home gateway.

The method 300 then ends in step 316.

Although not expressly specified above, one or more steps of the method 200 or the method 300 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing device specifically programmed to perform the functions described herein. For example, any one or more components or devices illustrated in FIG. 1 or described in connection with the method 200 or the method 300 may be implemented as the system 400. For instance, a set top box including an embedded position sensor (such as might be used to perform the method 200) or a server (such as might be used to perform the method 300) could be implemented as illustrated in FIG. 4.

As depicted in FIG. 4, the system 400 comprises a hardware processor element 402, a memory 404, a module 405 for monitoring the location of a set top box, and various input/output (I/O) devices 406.

The hardware processor 402 may comprise, for example, a microprocessor, a central processing unit (CPU), or the like. The memory 404 may comprise, for example, random access memory (RAM), read only memory (ROM), a disk drive, an optical drive, a magnetic drive, and/or a Universal Serial Bus (USB) drive. The module 405 for monitoring the location of a set top box includes circuitry and logic for performing special purpose functions relating to the operation of a set top box. The input/output devices 406 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor such as a position sensor.

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one embodiment, instructions and data for the present module or process 405 for monitoring the location of a set top box (e.g., a software program comprising computer-executable instructions) can be loaded into memory 404 and executed by hardware processor element 402 to implement the steps, functions or operations as discussed above in connection with the example method 200 or the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for monitoring the location of a set top box (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

Examples of the present disclosure may be implemented in manners other than what is described above. For instance, the above examples describe only some ways in which the location of equipment can be used to control the distribution of satellite television services and other content. In another example, a “smart” satellite receiver could include an embedded location sensor, and the location of the satellite receiver could be monitored to determine when it moves beyond a predefined geographic radius.

In further examples still, the STB may be configured to accept data streams only from a preselected satellite receiver, which may identify itself to the STB based on some unique identifier included in forwarded data streams. When the STB identifies a received data stream that originates from a satellite receiver other than the preselected receiver, it may send a signal to the server (instead of or in addition to the signal including the location information described above) that reports the receipt of the data stream from the potentially unauthorized receiver.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

1. A device, comprising:
a processor; and
a computer-readable medium storing instructions which, when executed by the processor, cause the processor to perform operations, the operations comprising:
determining a time to send a current geographic location of the device to a remote server, wherein the determining comprises detecting, by the device, that the current geographic location represents a change from a geographic previous location that is larger than a predefined amount;
sending a first signal to the remote server, wherein the current geographic location is encoded in the first signal;
extracting an instruction from a second signal sent by the remote server in response to the first signal; and
taking an action in response to the instruction, wherein the action alters an ability of the device to process a satellite television broadcast signal.

2. The device of claim 1, wherein the device is a set top box.

3. The device of claim 1, wherein the device is a satellite receiver.

4. The device of claim 1, wherein the device includes an embedded position sensor to monitor the current geographic location.

5. A method, comprising:
determining, by a device, a time to send a current geographic location of the device to a remote server, wherein the determining comprises detecting, by the device, that the current geographic location represents a change from a previous geographic location that is larger than a predefined amount;
sending, by the device, a first signal to the remote server, wherein the current geographic location is encoded in the first signal;
extracting, by the device, an instruction from a second signal sent by the remote server in response to the first signal; and
taking an action, by the device, in response to the instruction, wherein the action alters an ability of the device to process a satellite television broadcast signal.

6. The method of claim 5, wherein the device is a set top box.

7. The method of claim 5, wherein the device is a satellite receiver.

8. The method of claim 5, further comprising:
monitoring, by the device, the current geographic location using a position sensor embedded in the device.

9. The method of claim 5, wherein the determining comprises:
selecting the time in accordance with a periodic basis.

10. The method of claim 5, wherein the determining comprises:
selecting the time randomly.

11. (canceled)

12. The method of claim 5, wherein the action comprises ceasing, at least temporarily, reception by the device of the satellite television broadcast signal.

13. The method of claim 5, wherein the action comprises ceasing, at least temporarily, playback by the device of content decoded from the satellite television broadcast signal.

14. The method of claim 5, wherein the first signal further encodes a report that the device has received the satellite television broadcast signal from a satellite receiver other than a preselected satellite receiver from which the device is configured to accept satellite television broadcast signals.

15. A method, comprising:
extracting, by a server, a geographic location from a first signal sent by a remote device;
identifying, by the server, the remote device using identifying data extracted from the first signal;
determining, by the server, that the geographic location is outside of a geographic radius within which the remote device is permitted to operate; and
in response to the determining, sending, by the server, a second signal to the remote device, wherein the second signal encodes an instruction instructing the remote device to take an action that alters an ability of the remote device to process a satellite television broadcast signal.

16. The method of claim 15, wherein the remote device is a set top box.

17. The method of claim 15, wherein the remote device is a satellite receiver.

18. The method of claim 15, wherein the action comprises ceasing, at least temporarily, reception by the remote device of the satellite television broadcast signal.

19. The method of claim 15, wherein the action comprises ceasing, at least temporarily, playback by the remote device of content decoded from the satellite television broadcast signal.

20. The method of claim 15, wherein the first signal further encodes a report that the remote device has received the satellite television broadcast signal from a satellite receiver other than a preselected satellite receiver from which the device is configured to accept satellite television broadcast signals.
